(19) United States
(12) Patent Application Publication
(10) Pub. No.: US 2026/0342246 A1
(43) Pub. Date: Oct. 29, 2026

(54) Servo Motor, Control Method For Same, And Servo Driver

(71) Applicant: Siemens Aktiengesellschaft, München (DE)

(72) Inventor: Jun Ping Zhang, Nanjing (CN)

(73) Assignee: Siemens Aktiengesellschaft, München (DE)

(21) Appl. No.: 19/116,936

(22) PCT Filed: Sep. 30, 2022
(86) PCT No.: PCT/CN2022/123522

§ 371 Date: Mar. 28, 2025

(51) Int. Cl. H02P 3/22

(52) U.S. Cl. CPC H02P 3/22

(57) ABSTRACT

A control method for a servo motor includes: in a process of pre-charging the bus capacitor, in a case that a voltage of the bus capacitor than a predetermined first voltage value, releasing the short circuit between the two terminals of the pre-charge resistor, and establishing a short circuit between at least two phases of the AC power output terminal of the inverter unit; and in the process of pre-charging the bus capacitor, in a case that the voltage of the bus capacitor is greater than the predetermined first voltage value, short-circuiting the two terminals of the pre-charge resistor, and releasing a short circuit between any two phases of the AC power output terminal of the inverter unit.

### CROSS-REFERENCE TO RELATED APPLICATIONS

This application is a U.S. National Stage Application of International Application No. PCT/CN2022/123522 filed Sep. 30, 2022, which designates the United States of America, the contents of which are hereby incorporated by reference in their entirety.

### TECHNICAL FIELD

The present disclosure relates to motor driving. Various embodiments of the teachings herein include control methods for a servo motor, servo drivers, and servo motors including the servo driver.

### BACKGROUND

For a servo driver, in order to make a motor capable of stopping quickly in case of power off of a mains power source, generally, a braking function is configured in the servo driver. At present, costs in software development and hardware for additionally configuring the braking function are high.

### SUMMARY

Teachings of the present disclosure include control methods for a servo motor conducive to lowering costs in additional configuring a braking function. Some embodiments include a servo driver conducive to lowering costs in additional configuring a braking function. Some embodiments include a servo driver conducive to lowering costs in additional configuring a braking function.

For example, some embodiments include a control method for a servo motor, the servo motor comprising a servo driver and a motor, the servo driver comprising a rectifier unit, a DC bus, an inverter unit, a bus capacitor, and a pre-charge resistor, the rectifier unit being connected to an AC mains power source and capable of converting an AC power to a DC power, the DC bus being connected to a DC power output terminal of the rectifier unit, the inverter unit being connected to the DC bus and capable of converting a DC power to an AC power, the motor being connected to an AC power output terminal of the inverter unit, the bus capacitor and the pre-charge resistor being connected in series and subsequently connected between positive and negative terminals of the DC bus, two terminals of the pre-charge resistor being short-circuited by a circuit, wherein the control method comprises: in a process of pre-charging the bus capacitor, in a case that a voltage of the bus capacitor is less than a predetermined first voltage value, releasing the short circuit between the two terminals of the pre-charge resistor, and establishing a short circuit between at least two phases of the AC power output terminal of the inverter unit; and in the process of pre-charging the bus capacitor, in a case that the voltage of the bus capacitor is greater than the predetermined first voltage value, short-circuiting the two terminals of the pre-charge resistor, and releasing a short circuit between any two phases of the AC power output terminal of the inverter unit.

In some embodiments, the control method further comprises: in a process of discharging the bus capacitor upon power off of the AC mains power source, in a case that the voltage of the bus capacitor is greater than a predetermined second voltage value, short-circuiting the two terminals of the pre-charge resistor, and releasing the short circuit between the any two phases of the AC power output terminal of the inverter unit, wherein the predetermined second voltage value is less than the predetermined first voltage value; and in the process of discharging the bus capacitor upon power off of the AC mains power source, in a case that the voltage of the bus capacitor is less than the predetermined second voltage value, releasing the short circuit between the two terminals of the pre-charge resistor, and establishing the short circuit between the at least two phases of the AC power output terminal of the inverter unit.

In some embodiments, the control method further comprises: in a case that the bus capacitor is fully charged, short-circuiting the two terminals of the pre-charge resistor, and releasing the short circuit between the any two phases of the AC power output terminal of the inverter unit.

In some embodiments, the control method further comprises: in the process of pre-charging the bus capacitor, in the case that the voltage of the bus capacitor is less than the predetermined first voltage value, controlling the inverter unit to stop outputting power; and in the process of pre-charging the bus capacitor, in the case that the voltage of the bus capacitor is greater than the predetermined first voltage value, controlling the inverter unit to supply power to the motor.

In some embodiments, the control method further comprises: in the process of discharging the bus capacitor upon power off of the AC mains power source, in a case that the voltage of the bus capacitor is greater than a predetermined third voltage value, controlling the inverter unit to supply power to the motor, wherein the predetermined third voltage value is less than or equal to the predetermined first voltage value and greater than the predetermined second voltage value; and in the process of discharging the bus capacitor upon power off of the AC mains power source, in a case that the voltage of the bus capacitor is less than the predetermined third voltage value, controlling the inverter unit to switch to a free stop mode or a deceleration stop mode.

In some embodiments, the control method further comprises, in a case that the bus capacitor is fully charged, controlling the inverter unit to supply power to the motor.

As another example, some embodiments include a servo driver, configured to drive a motor (200), wherein the servo driver comprises: a rectifier unit (10), configured to be connected to an AC mains power source and being capable of converting an AC power to a DC power; a DC bus (20), connected to a DC power output terminal of the rectifier unit (10) ; an inverter unit (30), connected to the DC bus (20) and being capable of converting an DC power to an AC power, wherein an AC power output terminal of the inverter unit (30) is connected to the motor (200); a pre-charge circuit (40), comprising a bus capacitor (41) and a pre-charge resistor (42), wherein the bus capacitor (41) and the pre-charge resistor (42) are connected in series and subsequently connected between positive and negative terminals of the DC bus (20); a switch unit (50), connected to the pre-charge circuit (40) to be capable of short-circuiting two terminals of the pre-charge resistor (42), wherein the switch unit (50) is connected to at least two phases of the AC power output terminal of the inverter unit (30) to be capable of establishing a short circuit between the at least two phases of the AC power output terminal of the inverter unit (30); a voltage detection unit (60), capable of detecting a voltage of the bus capacitor (41) and generating a voltage signal; and a control unit (70), capable of controlling the switch unit (50) based on the voltage signal, such that: in a process of pre-charging the bus capacitor (41), in a case that the voltage of the bus capacitor (41) is less than a predetermined first voltage value, the short circuit between the two terminals of the pre-charge resistor (42) is released, and the short circuit is established between the at least two phases of the AC power output terminal of the inverter unit (30); and in the process of pre-charging the bus capacitor (41), in the case that the voltage of the bus capacitor (41) is greater than the predetermined first voltage value, the two terminals of the pre-charge resistor (42) are short-circuited, and a short circuit between any two phases of the AC power output terminal of the inverter unit (30) is released.

In some embodiments, the control unit (70) is capable of controlling the switch unit (50) based on the voltage signal, such that: in a process of discharging the bus capacitor (41) upon power off of the AC mains power source, in a case that the voltage of the bus capacitor (41) is greater than a predetermined second voltage value, the two terminals of the pre-charge resistor (42) are short-circuited, and the short circuit between the at any two phases of the AC power output terminal of the inverter unit (30) is released, wherein the predetermined second voltage value is less than the predetermined first voltage value; and in the process of discharging the bus capacitor (41) upon power off of the AC mains power source, in a case that the voltage of the bus capacitor (41) is less than the predetermined second voltage value, the short circuit between the two terminals of the pre-charge resistor (42) is released, and the short circuit is established between the at least two phases of the AC power output terminal of the inverter unit (30).

In some embodiments, the control unit (70) is capable of controlling the switch unit (50) based on the voltage signal, such that: in a case that the bus capacitor (41) is fully charged, the two terminals of the pre-charge resistor (42) are short-circuited, and the short circuit between the any two phases of the AC power output terminal of the inverter unit (30) is released.

In some embodiments, the switch unit (50) comprises a pair of contacts (53) and a group of second contacts (54), wherein the pair of contacts (53) is connected in parallel to the pre-charge resistor (42) and subsequently connected in parallel to the bus capacitor (41), and the group of second contacts (54) is connected to the AC power output terminal of the inverter unit (30).

In some embodiments, the switch unit (50) comprises a first relay (51) and a second relay (52), wherein the control unit (70) is connected to a control terminal of the first relay (51) and a control terminal of the second relay (52), a controlled terminal of the first relay (51) comprises the pair of first contacts (53), and a controlled terminal of the second relay (52) comprises the group of second contacts (54); or the switch unit (50) comprises a third relay (55), the control unit (70) is connected to a control terminal of the third relay (55), and a controlled terminal of the third relay (55) comprises the pair of first contacts (53) and the group of second contacts (54).

In some embodiments, the control unit (70) is capable of controlling the inverter unit (30) based on the voltage signal, such that: in the process of pre-charging the bus capacitor (41), in the case that the voltage of the bus capacitor (41) is less than a predetermined first voltage value, the inverter unit (30) stops outputting power; and in the process of pre-charging the bus capacitor (41), in the case that the voltage of the bus capacitor (41) is greater than the predetermined first voltage value, the inverter unit (30) supplies power to the motor (200).

In some embodiments, the control unit (70) is capable of controlling the inverter unit (30) based on the voltage signal, such that: in the process of discharging the bus capacitor (41) upon power off of the AC mains power source, in a case that the voltage of the bus capacitor (41) is greater than a predetermined third voltage value, the inverter unit (30) supplies power to the motor (200), wherein the predetermined third voltage value is less than or equal to the predetermined first voltage value and greater than the predetermined second voltage value; and in the process of discharging the bus capacitor (41) upon power off of the AC mains power source, in a case that the voltage of the bus capacitor (41) is less than the predetermined third voltage value, the inverter unit (30) switches to a free stop mode or a deceleration stop mode.

In some embodiments, the control unit (70) is capable of controlling the inverter unit (30) based on the voltage signal, such that: in a case that the bus capacitor (41) is fully charged, the inverter unit (30) supplies power to the motor (200).

As another example, some embodiments include a servo motor, comprising: a motor (200) and a servo driver as described herein.

### BRIEF DESCRIPTION OF THE DRAWINGS

The accompanying drawings are merely for schematic and illustrative description and demonstration of the present disclosure, instead of limiting the scope of the present disclosure. In the figures:

FIG. 1 is a flowchart of an example control method for a servo motor incorporating teachings of the present disclosure;

FIG. 2 is a schematic structural diagram of an example servo motor incorporating teachings of the present disclosure;

FIG. 3 illustrates a time correspondence relationship between a voltage of a bus capacitor and connection and disconnection of a pair of first contacts and connection and disconnection of a pair of second contacts; and

FIG. 4 is a schematic diagram of an example servo motor incorporating teachings of the present disclosure.

### REFERENCE NUMERALS AND DENOTATIONS THEREOF

10—Rectifier unit
20—DC bus
30—Inverter unit
40—Pre-charge circuit
41—Bus capacitor
42—Pre-charge resistor
50—Switch unit
51—First relay
53—First contact
52—Second relay
54—Second contact
55—Third relay
60—Voltage detection unit
70—Control unit
100—Servo driver
200—Motor

### DETAILED DESCRIPTION

Various embodiments of the present disclosure provide a control method for a servo motor. The servo motor includes a servo driver and a motor. The servo driver includes a rectifier unit, a DC bus, an inverter unit, a bus capacitor, and a pre-charge resistor. The rectifier unit is connected to an AC mains power source and capable of converting an AC power to a DC power. The DC bus is connected to a DC power output terminal of the rectifier unit. The inverter unit being connected to the DC bus and capable of converting a DC power to an AC power. The motor is connected to an AC power output terminal of the inverter unit. The bus capacitor and the pre-charge resistor are connected in series and subsequently connected between positive and negative terminals of the DC bus. Two terminals of the pre-charge resistor are short-circuited by a circuit. The control method includes: in a process of pre-charging the bus capacitor, in a case that a voltage of the bus capacitor is less than a predetermined first voltage value, releasing the short circuit between the two terminals of the pre-charge resistor, and establishing a short circuit between at least two phases of the AC power output terminal of the inverter unit; and in the process of pre-charging the bus capacitor, in a case that the voltage of the bus capacitor is greater than the predetermined first voltage value, short-circuiting the two terminals of the pre-charge resistor, and releasing a short circuit between any two phases of the AC power output terminal of the inverter unit.

In the control method for the servo motor, in startup of the servo motor, activation and deactivation of short circuit braking are associated with switching of charge modes of a pre-charge circuit, which is conducive to lowering costs in additional configuring a brake function.

In some embodiments, the control method further includes: in a process of discharging the bus capacitor upon power off of the AC mains power source, in a case that the voltage of the bus capacitor is greater than a predetermined second voltage value, short-circuiting the two terminals of the pre-charge resistor, and releasing the short circuit between the any two phases of the AC power output terminal the inverter unit, wherein the predetermined second voltage value is less than the predetermined first voltage value; and in the process of discharging the bus capacitor upon power off of the AC mains power source, in a case that the voltage of the bus capacitor is less than the predetermined second voltage value, releasing the short circuit between the two terminals of the pre-charge resistor, and establishing the short circuit between the at least two phases of the AC power output terminal of the inverter unit. In this way, costs in additionally configuring a braking function are further lowered.

In some embodiments, the control method further includes: in a case that the bus capacitor is fully charged, short-circuiting the two terminals of the pre-charge resistor, and releasing the short circuit between the any two phases of the AC power output terminal of the inverter unit. In this way, costs in additionally configuring a braking function are further lowered.

In some embodiments, the control method further includes: in the process of pre-charging the bus capacitor, in the case that the voltage of the bus capacitor is less than the predetermined first voltage value, controlling the inverter unit to stop outputting power; and in the process of pre-charging the bus capacitor, in the case that the voltage of the bus capacitor is greater than the predetermined first voltage value, controlling the inverter unit to supply power to the motor. In this way, costs in additionally configuring a braking function are further lowered.

In some embodiments, the control method further includes: in the process of discharging the bus capacitor upon power off of the AC mains power source, in a case that the voltage of the bus capacitor is greater than a predetermined third voltage value, controlling the inverter unit to supply power to the motor, wherein the predetermined third voltage value is less than or equal to the predetermined first voltage value and greater than the predetermined second voltage value; and in the process of discharging the bus capacitor upon power off of the AC mains power source, in a case that the voltage of the bus capacitor is less than the predetermined third voltage value, controlling the inverter unit to switch to a free stop mode or a deceleration stop mode. In this way, safety in stopping cars is enhanced.

In some embodiments, the control method further includes: in a case that the bus capacitor is fully charged, controlling the inverter unit to supply power to the motor.

Various embodiments of the present disclosure include servo drivers configured to drive a motor. The servo driver includes a rectifier unit, a DC bus, an inverter unit, a pre-charge circuit, a switch unit, a voltage detection unit, and a control unit. The rectifier unit is configured to be connected to an AC mains power source and capable of converting an AC power to a DC power. The DC bus is connected to a DC power output terminal of the rectifier unit. The inverter unit is connected to the DC bus and capable of converting an DC power to an AC power. An AC power output terminal of the inverter unit is connected to the motor. The pre-charge circuit includes a bus capacitor and a pre-charge resistor. The bus capacitor and the pre-charge resistor are connected in series and subsequently connected between positive and negative terminals of the DC bus. The switch unit is connected to the pre-charge circuit to be capable of short-circuiting two terminals of the pre-charge resistor. The switch unit is connected to at least two phases of the AC power output terminal of the inverter unit to be capable of establishing a short circuit between the at least two phases of the AC power output terminal of the inverter unit. The voltage detection unit is capable of detecting a voltage of the bus capacitor and generating a voltage signal. The control unit is capable of controlling the switch unit based on the voltage signal, such that: in a process of pre-charging the bus capacitor, in a case that the voltage of the bus capacitor is less than a predetermined first voltage value, the short circuit between the two terminals of the pre-charge resistor is released, and the short circuit is established between the at least two phases of the AC power output terminal of the inverter unit; and in the process of pre-charging the bus capacitor, in the case that the voltage of the bus capacitor is greater than the predetermined first voltage value, the two terminals of the pre-charge resistor are short-circuited, and a short circuit between any two phases of the AC power output terminal of the inverter unit is released.

The servo driver, by detecting the voltage of the bus capacitor, is capable of synchronously controlling state switching of short circuit braking, and switching of the charge modes of the pre-charge circuit. The servo driver is conducive to lowering costs in additionally configuring a braking function.

In some embodiments, the control unit is capable of controlling the switch unit based on the voltage signal, such that: in a process of discharging the bus capacitor upon power off of the AC mains power source, in a case that the voltage of the bus capacitor is greater than a predetermined second voltage value, the two terminals of the pre-charge resistor are short-circuited, and the short circuit between the at any two phases of the AC power output terminal of the inverter unit is released, wherein the predetermined second voltage value is less than the predetermined first voltage value; and in the process of discharging the bus capacitor upon power off of the AC mains power source, in a case that the voltage of the bus capacitor is less than the predetermined second voltage value, the short circuit between the two terminals of the pre-charge resistor is released, and the short circuit is established between the at least two phases of the AC power output terminal of the inverter unit. In this way, costs in additionally configuring a braking function are further lowered.

In some embodiments, the control unit is capable of controlling the switch unit based on the voltage signal, such that: in a case that the bus capacitor is fully charged, the two terminals of the pre-charge resistor are short-circuited, and the short circuit between the any two phases of the AC power output terminal of the inverter unit is released. In this way, costs in additionally configuring a braking function are further lowered.

In some embodiments, the switch unit includes a pair of contacts and a group of second contacts. The pair of contacts is connected in parallel to the pre-charge resistor and subsequently connected in parallel to the bus capacitor. The group of second contacts is connected to the AC power output terminal of the inverter unit.

In some embodiments, the switch unit includes a first relay and a second relay. The control unit is connected to a control terminal of the first relay and a control terminal of the second relay. A controlled terminal of the first relay includes the pair of first contacts. A controlled terminal of the second relay includes the group of second contacts.

In some embodiments, the switch unit includes a third relay. The control unit is connected to a control terminal of the third relay. A controlled terminal of the third relay includes the pair of first contacts and the group of second contacts.

In some embodiments, the control unit is capable of controlling the inverter unit based on the voltage signal, such that: in the process of pre-charging the bus capacitor, in the case that the voltage of the bus capacitor is less than a predetermined first voltage value, the inverter unit stops outputting power; and in the process of pre-charging the bus capacitor, in the case that the voltage of the bus capacitor is greater than the predetermined first voltage value, the inverter unit supplies power to the motor. In this way, costs in additionally configuring a braking function are further lowered.

In some embodiments, the control unit is capable of controlling the inverter unit based on the voltage signal, such that: in the process of discharging the bus capacitor upon power off of the AC mains power source, in a case that the voltage of the bus capacitor is greater than a predetermined third voltage value, the inverter unit supplies power to the motor, wherein the predetermined third voltage value is less than or equal to the predetermined first voltage value and greater than the predetermined second voltage value; and in the process of discharging the bus capacitor upon power off of the AC mains power source, in a case that the voltage of the bus capacitor is less than the predetermined third voltage value, the inverter unit switches to a free stop mode or a deceleration stop mode In this way, safety in stopping cars is enhanced.

In some embodiments, the control unit is capable of controlling the inverter unit based on the voltage signal, such that: in a case that the bus capacitor is fully charged, the inverter unit supplies power to the motor.

Various embodiments of the present disclosure include a servo motor. The servo motor includes a motor and a servo motor as described above. The servo driver, by detecting the voltage of the bus capacitor, is capable of synchronously controlling state switching of short circuit braking, and switching of the charge modes of the pre-charge circuit. The servo driver is conducive to lowering costs in additionally configuring a braking function.

For clearer descriptions of the technical features, objects, and the effects of the teachings of the present disclosure, the specific embodiments of the present disclosure are hereinafter described with reference to the accompanying drawings. In the drawings, like reference numerals denote elements having the same structure or having the similar structure but the same function. In this specification, the term “exemplary” or “schematic” is used herein to mean “serving as an example, instance, or illustration,” and any illustration or embodiment described herein as “exemplary” shall not be necessarily construed as preferred or advantageous over other illustrations or embodiments.

In this text, the terms “first,” “second,” and the like do not represent degrees of importance or a sequence, but only for differentiation, and for ease of description. For brevity, parts relevant to the present disclosure are merely illustrated in the drawings, and these parts do not denote the actual structure of the product.

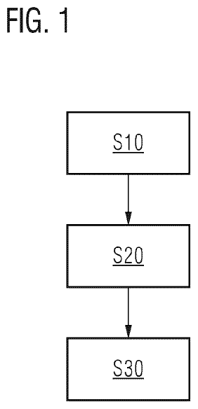

FIG. 1 is a flowchart of an example control method for a servo motor incorporating teachings of the present disclosure. The servo motor includes a servo driver and a motor. The motor is, for example, a permanent-magnet synchronous motor or a separately excited motor.

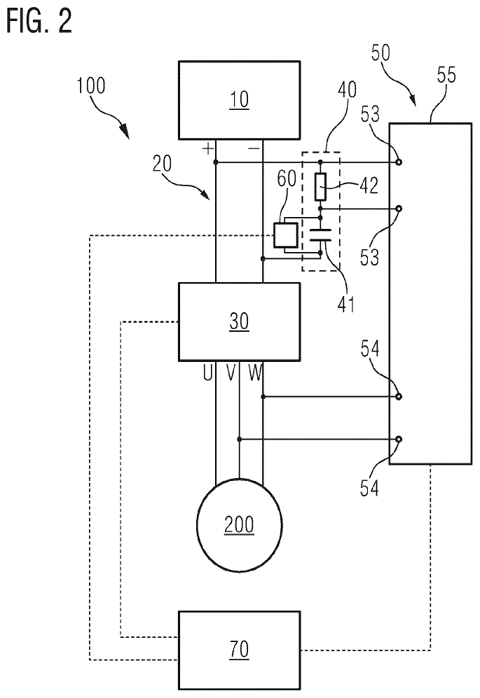

As illustrated in FIG. 2, a servo driver 100 of the servo motor, for example, includes a rectifier unit 10, a DC bus 20, an inverter unit 30, a pre-charge circuit 40, and a switch unit 50. The rectifier unit 10 is configured to be connected to an AC mains power source and capable of converting an AC power to a DC power. The DC bus 20 is connected to a DC power output terminal of the rectifier unit 10. The inverter unit 30 is connected to the DC bus 20 and capable of converting an DC power to an AC power. An AC power output terminal of the inverter unit 30 is connected to a motor 200. The pre-charge circuit 40 includes a bus capacitor 41 and a pre-charge resistor 42. The bus capacitor 41 and the pre-charge resistor 42 are connected in series and subsequently connected between positive and negative terminals of the DC bus 20. The switch unit 50 includes a pair of first contacts 53 and a pair of second contacts 54. The pair of contacts 53 is connected in parallel to the pre-charge resistor 42 and subsequently connected in parallel to the bus capacitor 41. The group of second contacts 54 is connected to two phases of the AC power output terminal of the inverter unit 30. The pair of first contacts 53 is conducted, and then two terminals of the pre-charge resistor 42 are short-circuited. The pair of second contacts 54 is conducted, and then a short circuit is established between two phases of the AC power output terminal of the inverter unit 30. A specific example of the servo driver is given merely for illustrating the control method according to this exemplary embodiment. However, the control method according to this embodiment is not limited to implementation based on this specific example.

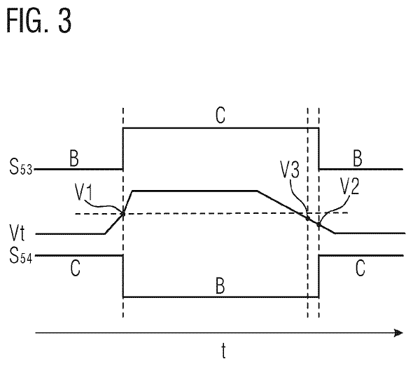

As illustrated in FIG. 1, the control method includes the following steps S10 to S30. FIG. 3 illustrates a time correspondence relationship between a voltage of a bus capacitor and connection and disconnection of a pair of first contacts and connection and disconnection of a pair of second contacts. As illustrated in FIG. 3, an abscissa represents time t, Vt represents a variation of the voltage of the bus capacitor with time, S53 represents connection and disconnection of a pair of first contacts 53, S54 represents connection and disconnection of a pair of second contacts 54, B represents disconnection, and C represents connection.

In S10, in a process of pre-charging the bus capacitor 41, in a case that a voltage of the bus capacitor 41 is less than a predetermined first voltage value V1, the short circuit between the two terminals of the pre-charge resistor 42 is released (that is, the pair of first contacts 53 is disconnected) such that the pre-charge resistor is in a low-voltage charge mode, and the short circuit is established between at least two phases of the AC power output terminal of the inverter unit 30 (that is, the pair of second contacts 54 is connected) such that short circuit braking of the servo motor is in an activated state. In the process of pre-charging the bus capacitor 41, in a case that a voltage of the bus capacitor 41 is greater than the predetermined first voltage value V1, the two terminals of the pre-charge resistor 42 are short-circuited (that is, the pair of first contacts 53 is connected) such that the pre-charge circuit is in a high-voltage charge mode, and the short circuit between at least two phases of the AC power output terminal of the inverter unit 30 is released (that is, the pair of second contacts 54 is disconnected) such that short circuit braking of the servo motor is in a deactivated state. The first voltage value V1 needs to be defined according to the needs of pre-charging, which is generally 90% of the voltage of the DC bus but is not limited to this value.

In this way, in startup of the servo motor, activation and deactivation of short circuit braking are associated with switching of charge modes of the pre-charge circuit, which is conducive to lowering costs in additionally configuring a braking function.

In S20, in a case that the bus capacitor 41 is fully charged, the two terminals of the pre-charge resistor 42 are short-circuited (that is, the pair of first contacts 53 is connected), and a short circuit between any two phases of the AC power output terminal of the inverter unit 30 is released (that is, the pair of second contacts 54 is disconnected) such that short circuit braking of the servo motor is in the deactivated state. In this way, in normal operation of the servo motor upon completion of startup, deactivation of short circuit braking is associated with a state where the bus capacitor is fully charged, which is conducive to further lowering costs in additionally configuring a braking function.

In S30, in a process of discharging the bus capacitor 41 upon power off of the AC mains power source, in a case that the voltage of the bus capacitor 41 is greater than a predetermined second voltage value V2, the two terminals of the pre-charge resistor 42 are short-circuited (that is, the pair of first contacts 53 is connected) such that the pre-charge circuit is in the high-voltage charge mode, and the short circuit between the any two phases of the AC power output terminal of the inverter unit 30 is released (that is, the pair of second contacts 54 is disconnected) such that short circuit braking of the servo motor is in the deactivated state. In the process of pre-charging the bus capacitor 41, in a case that the voltage of the bus capacitor 41 is less than the predetermined second voltage value V2, the short circuit between the two terminals of the pre-charge resistor 42 is released (that is, the pair of first contacts 53 is disconnected) such that the pre-charge circuit is in the low-voltage charge mode, and the short circuit is established between the at least two phases of the AC power output terminal of the inverter unit 30 (that is, the pair of second contacts 54 is connected) such that short circuit braking of the servo motor is in the activated state. The second voltage value V2 needs to be defined according to the need of braking, which should be less than the first voltage value V1. In this way, in shutdown of the servo motor, activation and deactivation of short circuit braking are associated with switching of charge modes of a pre-charge circuit, which is conducive to further lowering costs in additionally configuring a braking function.

In some embodiments, step S10 further includes: in the process of pre-charging the bus capacitor 41, in the case that the voltage of the bus capacitor 41 is less than the predetermined first voltage value V1, controlling the inverter unit 30 to stop outputting power; and in the process of pre-charging the bus capacitor 41, in the case that the voltage of the bus capacitor 41 is greater than the predetermined first voltage value V1, controlling the inverter unit 30 to supply power to the motor 200. In this way, in startup of the servo motor, activation and deactivation of short circuit braking are associated with switching of charge modes of a pre-charge circuit, which is conducive to lowering costs in additionally configuring a braking function.

In some embodiments, step S30 further includes: in the process of discharging the bus capacitor 41 upon power off of the AC mains power source, in a case that the voltage of the bus capacitor 41 is greater than a predetermined third voltage value V3, controlling the inverter unit 30 to supply power to the motor 200; and in the process of discharging the bus capacitor 41, in a case that the voltage of the bus capacitor 41 is less than the predetermined third voltage value V3, controlling the inverter unit 30 to switch to a free stop mode or a deceleration stop mode. The third voltage value V3 needs to be defined according to the need of braking, which should be less than or equal to the first voltage value V1 and greater than the second voltage value V2. In a process that the voltage of the bus capacitor 41 is decreased from the third voltage value V3 to the second voltage value V2, the motor 200 is gradually decelerated under the free stop mode or the deceleration stop mode, and short circuit braking is implemented in the case that the voltage of the bus capacitor 41 is decreased to the second voltage value V2. In this way, safety in stopping cars is enhanced. A difference between the third voltage value V3 and the second voltage value V2 ranges, for example, from 10 V to 20 V.

In some embodiments, step S20 further includes: in a case that the bus capacitor 41 is fully charged, controlling the inverter unit 30 to supply power to the motor.

Various embodiments of the present disclosure include a servo driver, which is configured to perform one or more of the control methods for the servo motor as described herein. The servo motor is configured to drive the motor, wherein the motor is, for example, a permanent-magnet synchronous motor or a separately excited motor. FIG. 2 illustrates an example servo driver incorporating teachings of the present disclosure. As illustrated in FIG. 2, a servo driver 100 includes a rectifier unit 10, a DC bus 20, an inverter unit 30, a pre-charge circuit 40, a switch unit 50, a voltage detection unit 60, and a control unit 70.

As illustrated in FIG. 2, the rectifier unit 10 is configured to be connected to an AC mains power source and capable of converting an AC power to a DC power. The DC bus 20 is connected to a DC power output terminal of the rectifier unit 10. The inverter unit 30 is connected to the DC bus 20 and capable of converting an DC power to an AC power. An AC power output terminal of the inverter unit 30 is configured to be connected to a motor 200.

The pre-charge circuit 40 includes a bus capacitor 41 and a pre-charge resistor 42. The bus capacitor 41 and the pre-charge resistor 42 are connected in series and subsequently connected between positive and negative terminals of the DC bus 20.

The switch unit 50 is connected to the pre-charge circuit 40 to be capable of short-circuiting two terminals of the pre-charge resistor 42. The switch unit 50 is connected to at least two phases of the AC power output terminal of the inverter unit 30 to be capable of establishing a short circuit between the at least two phases of the AC power output terminal of the inverter unit 30. Specifically, in the embodiment shown, the switch unit 50 includes a third relay 55. A controlled terminal of the third relay 55 includes a pair of first contacts 53 and a pair of second contacts 54. A pair of contacts 53 is connected in parallel to the pre-charge resistor 42 and subsequently connected in parallel to the bus capacitor 41. A pair of second contacts 54 is connected to two phases of the AC power output terminal of the inverter unit 30. The pair of first contacts 53 is conducted, and then two terminals of the pre-charge resistor 42 are short-circuited. The pair of second contacts 54 is conducted, and then the short circuit is established between two phases of the AC power output terminal of the inverter unit 30.

The voltage detection unit 60 is capable of detecting a voltage of the bus capacitor 41 and generating a voltage signal. The control unit 70 is connected to a control terminal of the third relay 55. The control unit 70 is capable of controlling the switch unit 50 based on the voltage signal, such that: in a process of pre-charging the bus capacitor 41, in a case that the voltage of the bus capacitor 41 is less than a predetermined first voltage value V1, the short circuit between the two terminals of the pre-charge resistor 42 is released (that is, the pair of first contacts 53 is disconnected) such that the pre-charge circuit is in a low-voltage charge mode, and the short circuit is established between the at least two phases of the AC power output terminal of the inverter unit 30 (that is, the pair of second contacts 54 is connected) such that short circuit braking of the servo motor is in an activated state; and in the process of pre-charging the bus capacitor 41, in a case that the voltage of the bus capacitor 41 is greater than the predetermined first voltage value V1, the two terminals of the pre-charge resistor 42 are short-circuited (that is, the pair of first contacts 53 is connected) such that the pre-charge circuit is in a high-voltage charge mode, and a short circuit between any two phases of the AC power output terminal of the inverter unit 30 is released (that is, the pair of second contacts 54 is disconnected) such that the short circuit braking of the servo motor is in a deactivated state. The first voltage value V1 needs to be defined according to the needs of pre-charging, which is generally 90% of the voltage of the DC bus, but is not limited to this value.

The servo driver, by detecting the voltage of the bus capacitor, is capable of synchronously controlling state switching of short circuit braking and switching of the charge modes of the pre-charge circuit. The servo driver is conducive to lowering costs in additionally configuring a braking function.

In some embodiments, the control unit 70 is capable of controlling the switch unit 50 based on the voltage signal, such that: in a process of discharging the bus capacitor 41 upon power off of the AC mains power source, in a case that the voltage of the bus capacitor 41 is greater than a predetermined second voltage value V2, the two terminals of the pre-charge resistor 42 are short-circuited (that is, the pair of first contacts 53 is connected) such that the pre-charge circuit is in the high-voltage charge mode, and the short circuit between the at least two phases of the AC power output terminal of the inverter unit 30 is released (that is, the pair of second contacts 54 is disconnected) such that short circuit braking of the servo motor is in the deactivated state; and in the process of discharging the bus capacitor 41 upon power off of the AC mains power source, in a case that the voltage of the bus capacitor 41 is less than the predetermined second voltage value V2, the short circuit between the two terminals of the pre-charge resistor 42 is released (that is, the pair of first contacts 53 is disconnected) such that the pre-charge circuit is in the low-voltage charge mode, and the short circuit is established between the at least two phases of the AC power output terminal of the inverter unit 30 (that is, the pair of second contacts 54 is connected), such that the short circuit braking of the servo motor is in the activated state. The second voltage value V2 needs to be defined according to the need of braking, which should be less than the first voltage value V1. In this way, in shutdown of the servo motor, activation and deactivation of short circuit braking are associated with switching of charge modes of a pre-charge circuit, which is conducive to further lowering costs in additionally configuring a braking function.

In some embodiments, the control unit 70 is capable of controlling the switch unit 50 based on the voltage signal, such that: in a case that the bus capacitor 41 is fully charged, the two terminals of the pre-charge resistor 42 are short-circuited (that is, the pair of first contacts 53 is connected), and a short circuit between any two phases of the AC power output terminal of the inverter unit 30 is released (that is, the pair of second contacts 54 is disconnected), such that short circuit braking of the servo motor is in the deactivated state. In this way, in normal operation of the servo motor upon completion of startup, deactivation of short circuit braking is associated with a state where the bus capacitor is fully charged, which is conducive to further lowering costs in additionally configuring a braking function.

In some exemplary embodiments, the control unit 70 is capable of controlling the inverter unit 30 based on the voltage signal, such that: in the process of pre-charging the bus capacitor 41, in the case that the voltage of the bus capacitor 41 is less than a predetermined first voltage value V1, the inverter unit 30 stops outputting power; and in the process of pre-charging the bus capacitor 41, in the case that the voltage of the bus capacitor 41 is greater than the predetermined first voltage value V1, the inverter unit 30 supplies power to the motor 200. In this way, in startup of the servo motor, activation and deactivation of short circuit braking are associated with switching of charge modes of a pre-charge circuit, which is conducive to lowering costs in additionally configuring a braking function.

In some embodiments, the control unit 70 is capable of controlling the inverter unit 30 based on the voltage signal, such that: in the process of discharging the bus capacitor 41 upon power off of the AC mains power source, in a case that the voltage of the bus capacitor 41 is greater than a predetermined third voltage value V3, the inverter unit 30 supplies power to the motor 200; and in the process of discharging the bus capacitor 41 upon power off of the AC mains power source, in a case that the voltage of the bus capacitor 41 is less than the predetermined third voltage value V3, the inverter unit 30 switches to a free stop mode or a deceleration stop mode The third voltage value V3 needs to be defined according to the need of braking, which should be less than or equal to the first voltage value V1 and greater than the second voltage value V2. In a process that the voltage of the bus capacitor 41 is decreased from the third voltage value V3 to the second voltage value V2, the motor 200 is gradually decelerated under the free stop mode or the deceleration stop mode, and short circuit braking is implemented in the case that the voltage of the bus capacitor 41 is decreased to the second voltage value V2. In this way, safety in stopping cars is enhanced. A difference between the third voltage value V3 and the second voltage value V2 ranges, for example, from 10 V to 20 V.

In some embodiments, the control unit 70 is capable of controlling the inverter unit 30 based on the voltage signal, such that: in a case that the bus capacitor 41 is fully charged, the inverter unit 30 supplies power to the motor 200.

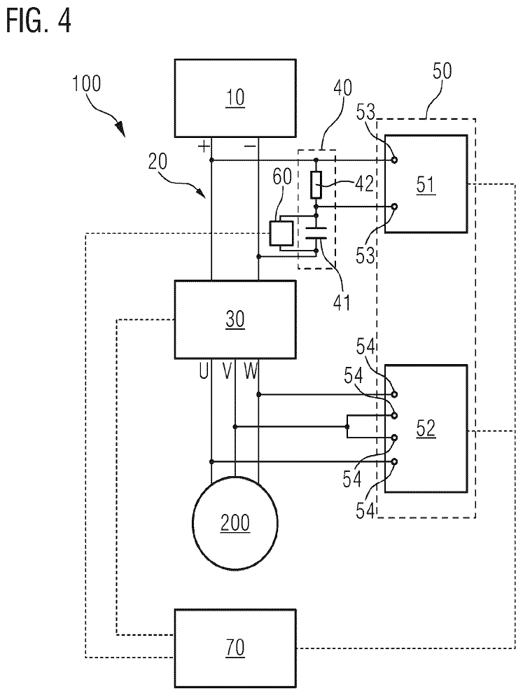

FIG. 4 illustrates an example servo driver incorporating teachings of the present disclosure. The common or similar points between the servo driver here and the servo driver as illustrated in FIG. 2 are not described herein any further, and the differences between these two servo drivers are described hereinafter. In some embodiments, the third relay 55 of the switch unit 50 is replaced by a first relay 51 and a second relay 52. The control unit 70 is connected to a control terminal of the first relay 51 and a control terminal of the second relay 52. A controlled terminal of the first relay 51 includes a pair of first contacts 53, and the controlled terminal of the second relay 52 includes two pairs of second contacts 54. A pair of contacts 53 is connected in parallel to the pre-charge resistor 42 and subsequently connected in parallel to the bus capacitor 41. Two pairs of second contacts 54 are connected to the AC output terminal of the inverter unit 30, and short circuits are established between three phases of the AC output terminal of the inverter unit 30 by connecting the two pairs of second contacts 54 (that is, a pair of second contacts 54 at an upper side in FIG. 4 is connected, and a pair of second contacts 54 at a lower side in FIG. 4 is connected). In this embodiment, the time for connection and disconnection of a pair of first contacts 53 is the same as the time for connection and disconnection of a pair of first contacts 53 described in the servo driver as illustrated in FIG. 2. In this embodiment, the time for connection and disconnection of a pair of second contacts 54 is the same as the time for connection and disconnection of a pair of second contacts 54 described in the servo driver as illustrated in FIG. 2.

The servo driver, by detecting the voltage of the bus capacitor, is capable of synchronously controlling state switching of short circuit braking and switching of the charge modes of the pre-charge circuit. The servo driver is conducive to lowering costs in additionally configuring a braking function.

Various embodiments of the present disclosure include a servo motor. In some embodiments, the servo motor includes a motor 200 and a servo driver 100 as illustrated in FIG. 2 or 4. The motor 200 is, for example, a permanent-magnet synchronous motor or a separately excited motor. The servo motor is conducive to lowering costs in additionally configuring a braking function.

In the deceleration stop mode, the inverter unit progressively decreases an output frequency in accordance with a predetermined deceleration time and decreases the frequency to 0 Hz such that the motor stops. In the free stop mode, the inverter stops outputting power and the motor stops freely according to a mechanical inertial force.

It should be understood that, although the teachings of this specification are described using the example embodiments, not each of the embodiments discloses an independent technical solution. Such description manner of the specification is only for clarity. A person skilled in the art should consider the specification as an entirety. The technical solutions according to the embodiments may also be suitably combined to derive other embodiments that may be understood by a person skilled in the art.

A series of detailed descriptions are merely intended to illustrate feasible embodiments of the present disclosure, instead of limiting the protection scope of the present disclosure. Any equivalent embodiments or modifications, for example, combinations, segmentations, or repetition of features, derived without departing from the spirit of the present disclosure shall fall within the protection scope of the present disclosure.

What is claimed is:

1. A control method for a servo motor including a servo driver and a motor, the servo driver comprising a rectifier unit, a DC bus, an inverter unit, a bus capacitor, and a pre-charge resistor, the rectifier unit Hing connected to an AC mains power source and to convert an AC power to a DC power, the DC bus connected to a DC power output terminal of the rectifier unit, the inverter unit are connected to the DC bus to convert a DC power to an AC power, the motor connected to an AC power output terminal of the inverter unit, the bus capacitor and the pre-charge resistor connected in series between positive and negative terminals of the DC bus, two terminals of the pre-charge resistor short-circuited by a circuit, the control method comprising:
pre-charging the bus capacitor, and if a voltage of the bus capacitor is less than a predetermined first voltage value, releasing the short circuit between the two terminals of the pre-charge resistor, and establishing a short circuit between at least two phases of the AC power output terminal of the inverter unit; and
if the voltage of the bus capacitor is greater than the predetermined first voltage value, short-circuiting the two terminals of the pre-charge resistor, and releasing a short circuit between any two phases of the AC power output terminal of the inverter unit.

2. The control method according to claim 1, further comprising:
discharging the bus capacitor upon power off of the AC mains power source, and if the voltage of the bus capacitor is greater than a predetermined second voltage value, short-circuiting the two terminals of the pre-charge resistor, and releasing the short circuit between the any two phases of the AC power output terminal of the inverter unit, wherein the predetermined second voltage value is less than the predetermined first voltage value; and
if the voltage of the bus capacitor is less than the predetermined second voltage value, releasing the short circuit between the two terminals of the pre-charge resistor, and establishing the short circuit between the at least two phases of the AC power output terminal of the inverter unit.

3. The control method according to claim 1, further comprising, if the bus capacitor is fully charged:
short-circuiting the two terminals of the pre-charge resistor; and
releasing the short circuit between the any two phases of the AC power output terminal of the inverter unit.

4. The control method according to claim 1, further comprising
while pre-charging the bus capacitor:
if the voltage of the bus capacitor is less than the predetermined first voltage value, controlling the inverter unit to stop outputting power; and
if the voltage of the bus capacitor is greater than the predetermined first voltage value, controlling the inverter unit to supply power to the motor.

5. The control method according to claim 2, further comprising
while discharging the bus capacitor:
the voltage of the bus capacitor is greater than a predetermined third voltage value, controlling the inverter unit to supply power to the motor, wherein the predetermined third voltage value is less than or equal to the predetermined first voltage value and greater than the predetermined second voltage value; and
if the voltage of the bus capacitor is less than the predetermined third voltage value, controlling the inverter unit to switch to a free stop mode or a deceleration stop mode.

6. The control method according to claim 1, further comprising, if bus capacitor is fully charged, controlling the inverter unit to supply power to the motor.

7. A servo driver to drive a motor, the servo driver comprising:
a rectifier unit to connect to an AC mains power source and convert an AC power to a DC power;
a DC bus connected to a DC power output terminal of the rectifier unit;
an inverter unit connected to the DC bus and to convert an DC power to an AC power, wherein an AC power output terminal of the inverter unit is connected to the motor;
a pre-charge circuit comprising a bus capacitor and a pre-charge resistor connected in series between positive and negative terminals of the DC bus;
a switch unit connected to the pre-charge circuit and operable to short-circuit two terminals of the pre-charge resistor, wherein the switch unit is connected to at least two phases of the AC power output terminal of the inverter unit to be operable to establish a short circuit between the at least two phases of the AC power output terminal of the inverter unit;
a voltage detection unit to detect a voltage of the bus capacitor and generate a voltage signal; and
a control unit to control the switch unit based on the voltage signal, in a process of pre-charging the bus capacitor, if the voltage of the bus capacitor is less than a predetermined first voltage value, the short circuit between the two terminals of the pre-charge resistor is released, and the short circuit is established between the at least two phases of the AC power output terminal of the inverter unit; and if the voltage of the bus capacitor is greater than the predetermined first voltage value, the two terminals of the pre-charge resistor are short-circuited, and a short circuit between any two phases of the AC power output terminal of the inverter unit is released.

8. The servo driver according to claim 7, wherein the control unit controls the switch unit based on the voltage signal, such that: in a process of discharging the bus capacitor upon power off of the AC mains power source, if the voltage of the bus capacitor is greater than a predetermined second voltage value, the two terminals of the pre-charge resistor are short-circuited, and the short circuit between the at any two phases of the AC power output terminal of the inverter unit is released, wherein the predetermined second voltage value is less than the predetermined first voltage value; and if the voltage of the bus capacitor is less than the predetermined second voltage value, the short circuit between the two terminals of the pre-charge resistor is released, and the short circuit is established between the at least two phases of the AC power output terminal of the inverter unit.

9. The servo driver according to claim 7, wherein the control unit controls the switch unit based on the voltage signal, such that: if the bus capacitor is fully charged, the two terminals of the pre-charge resistor are short-circuited, and the short circuit between the any two phases of the AC power output terminal of the inverter unit is released.

10. The servo driver according to claim 7, wherein:
the switch unit comprises a pair of contacts and a group of second contacts;
the pair of contacts is connected in parallel to the pre-charge resistor and subsequently connected in parallel to the bus capacitor; and
the group of second contacts is connected to the AC power output terminal of the inverter unit.

11. The servo driver according to claim 10, wherein:
the switch unit comprises a first relay and a second relay; and
the control unit is connected to a control terminal of the first relay and a control terminal of the second relay, a controlled terminal of the first relay comprises the pair of first contacts, and a controlled terminal of the second relay comprises the group of second contacts; or
the switch unit comprises a third relay, the control unit is connected to a control terminal of the third relay, and a controlled terminal of the third relay comprises the pair of first contacts and the group of second contacts.

12. The servo driver according to claim 7, wherein the control unit controls the inverter unit based on the voltage signal, such that: in the process of pre-charging the bus capacitor, if the voltage of the bus capacitor is less than a predetermined first voltage value, the inverter unit stops outputting power; and
if the voltage of the bus capacitor is greater than the predetermined first voltage value, the inverter unit supplies power to the motor.

13. The servo driver according to claim 8, wherein the control unit controls the inverter unit based on the voltage signal, such that: in the process of discharging the bus capacitor upon power off of the AC mains power source, if the voltage of the bus capacitor is greater than a predetermined third voltage value, the inverter unit supplies power to the motor, wherein the predetermined third voltage value is less than or equal to the predetermined first voltage value and greater than the predetermined second voltage value; and
if the voltage of the bus capacitor is less than the predetermined third voltage value, the inverter unit switches to a free stop mode or a deceleration stop mode.

14. The servo driver according to claim 7, wherein the control unit controls the inverter unit based on the voltage signal, such that: in a case that the bus capacitor is fully charged, the inverter unit supplies power to the motor.

15. A servo motor, comprising:
a motor; and
servo driver to drive the motor, the servo driver comprising:
a rectifier unit to connect to an AC mains power source and convert an AC power to a DC power;
a DC bus connected to a DC power output terminal of the rectifier unit;
an inverter unit connected to the DC bus and to convert an DC power to an AC power, wherein an AC power output terminal of the inverter unit is connected to the motor;
a pre-charge circuit comprising a bus capacitor and a pre-charge resistor connected in series between positive and negative terminals of the DC bus;
a switch unit connected to the pre-charge circuit and operable to short-circuit two terminals of the pre-charge resistor, wherein the switch unit is connected to at least two phases of the AC power output terminal of the inverter unit to be operable to establish a short circuit between the at least two phases of the AC power output terminal of the inverter unit;
a voltage detection unit to detect a voltage of the bus capacitor and generate a voltage signal; and
a control unit to control the switch unit based on the voltage signal, so: in a process of pre-charging the bus capacitor, if the voltage of the bus capacitor is less than a predetermined first voltage value, the short circuit between the two terminals of the pre-charge resistor is released, and the short circuit is established between the at least two phases of the AC power output terminal of the inverter unit; and if the voltage of the bus capacitor is greater than the predetermined first voltage value, the two terminals of the pre-charge resistor are short-circuited, and a short circuit between any two phases of the AC power output terminal of the inverter unit is released.
